(19) United States
(12) Patent Application Publication
(10) Pub. No.: US 2008/0206717 A1
(43) Pub. Date: Aug. 28, 2008

(54) Treatment Apparatus

(76) Inventor: Harald Mylius, Toging (DE)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(21) Appl. No.: 11/813,425

(22) PCT Filed: Jan. 5, 2006
(86) PCT No.: PCT/EP2006/000067

§ 371 Date: Jul. 5, 2007

(30) Foreign Application Priority Data
Jan. 8, 2005 (DE) 102005000950.6
May 12, 2005 (DE) 202005007563.9
Aug. 4, 2005 (DE) 202005012281.5

(51) Int. Cl. A61C 19/00; B01J 19/08

(52) U.S. Cl. 433/229; 422/186

(57) ABSTRACT

Disclosed is a treatment apparatus comprising a device which generates an electric or electromagnetic field having a field voltage of 1,800 to 35,000 V by means of a voltage of 12 to 600 V, a current strength of 0.1 ?A to 100 ?A, and a frequency of 10,000 to 35,000 Hz.

The invention relates to a treatment apparatus.

Bacteria, viruses and fungi have always presented a problem in humans and animals, particularly in dental treatment.

In EP 1 335 680 B1 is described a treatment apparatus for caries having an ozone generator from which ozone is guided into a hand piece via a conduit, said hand piece supplying the tooth to be treated with the ozone, and a beaker attached to the hand piece to receive the gas and to expose a selected area of the tooth to the ozone, the beaker being formed, so that it covers the selected area completely so the poisonous ozone cannot escape into the ambient air and protects the patient and the personnel carrying out the dental treatment, the ozone being aspirated again and lead back, where it will then be reduced. Due to its design this treatment apparatus is big and heavy.

It is an object of the invention to improve the prior art, particularly to provide a handy, small apparatus which hardly emits any damaging ozone and therefore requires no aspiration device and reduction source for reducing the ozone and nevertheless provides a harmless oxydising gas which may not only alleviate caries but also destroy any germs on the skin surface and at the tooth and in the oral cavity, and the treatment being, in particular, completely pain-free at the vital tooth.

The subject matter of the invention is a treatment apparatus having a device that produces an electric or electromagnetic field with a field voltage of 1800V to 35000V by means of a voltage of 12V to 600V, an amperage of 0.1 μA to 100 μA, and a frequency of 10000 Hz to 35000 Hz.

The electric or electromagnetic field is preferably produced by means of a voltage of 12V to 600V, preferred a voltage of 12V to 50V, particularly preferred of 18V to 28V, preferably an amperage of 0.1 μA to 100 μA, preferred an amperage of 0.1 μA to 20 μA, particularly preferred an amperage of 0.8 μA to 10 μA and preferably a frequency of 10000 to 50000 Hz, preferred a frequency of 25000 Hz to 40000 Hz, particularly preferred a frequency of 25000 Hz to 38000 Hz. The voltage in the electric or electromagnetic field is preferably 1800 to 35000V, preferred 8000 to 18000V and particularly preferred 12000 to 18000V.

The treatment apparatus according to the invention is preferably intended for use in humans and animals.

The treatment apparatus according to the invention preferably has, in a handle, a high voltage transformer with chamber winding in the form of serially connected coils, preferably 12 to 20, preferred 14 to 18, particularly preferred 16, preferably having a special core, preferably a bar core with an initial permeability pi of preferably 350 to 850, preferred 450 to 750, particularly preferred 550 to 650, exceptionally preferred 600 to produce a field voltage of 1800V to 35000V. The above-mentioned controlled frequency of 10000 Hz to 50000 Hz is built up with a repeat frequency of preferably 350 Hz to 500 Hz, preferred 400 Hz to 480 Hz, particularly preferred 430 Hz to 460 Hz, exceptionally preferred 450 Hz or preferably 1080 Hz to 1280 Hz (for pain-free caries treatment), preferred 1120 to 1240 Hz (for pain-free caries treatment). This pulse rate is achieved through a semi-conductor switch, preferably an MOS switching transistor, which is preferably placed in the handle to achieve a better performance without inductivity and capacitive losses of the supply cable. This pulse type is a short square pulse which excites a damped oscillation. The pulse width is adjustable between 1 and 30 μs, preferred 1 and 13 μs controlling the power of the production of atomic oxygen from 5% to 100% on the highest power level.

The small high voltage transformer wound in chambers is shielded in the handle and produces only minimal electromagnetic interferences. The housing leakage current is very low with a less than 10 μA at full power. With a patient current of more than 80 μA the electronics preferably switch off automatically. Healing time, patient current monitoring and switching off is preferably controlled via a microchip. In clinical trials a healing time of preferably 40 sec for a dental treatment was determined. This may preferably be indicated by a blip.

At the handle there is a probe, preferably a hollow glass probe filled with a gas, preferably an electroconductive gas, preferably filled with at least a noble gas or any noble gas mixtures. In a preferred embodiment the treatment probe comprises a cavity of glass, which may be evacuated or may not evacuated, preferably including a further cavity of glass being filled with gas and extending to the upper end of the treatment probe, thus passing into the tip of the treatment probe. The glass probe has, at its lower end, to which it is attached in the handle, preferably via a positive clamp connection, a cylinder shaped metal fastener. The upper end of the glass probe, i.e. the tip, is formed depending on the type of application. With applications in the denture it has a pointed, blunt or also expanded lentoid end and the tip itself may have a planar, convex or concave form. For applications at the skin surface, such as dermatological applications, a big lentoid end is preferred, so as to also be able to treat bigger surfaces. A probe for treating piles is pointed and long, having an extension in the centre, a probe for the neck of the womb is long and pointed, having a slightly angled tip. A probe for treating diseases of the scalp or hair follicles is in the form of a comb, the teeth of the comb being, in this case, U-shaped glass tubes that are connected to the carrier of the probe such that the U-shaped tubes are open toward the carrier of the probe, so that the gas may circulate unhampered in the entire probe. There are 1, 2, 3, 4, 5, 6, 7, 8, etc. teeth, 4 teeth being preferred. All probes may in principle also carry caps, preferably made of silicone, which serve as spacers or terminate in a capillary or are in the form of a beaker, which can grip around or over the tooth. The probe may also be formed such that it can receive in a more or less positive-fit whole body parts, such as a hand, a leg or a foot, etc. Furthermore, correspondingly formed glass probes may also be applied at the ear (auditory canal), intestinal portal, vagina, oral region (e.g. tongue, tonsils), as well as at muscles, joints, eyes (lids, eye ball), nose entrance, neck and back vertebrae, foot or hand (nails), etc. The glass probe is preferably filled with at least one conductive gas, preferably a noble gas, at a low pressure of preferably 0.1 to 1000 mbar, preferred 0.1 to 500 mbar, particularly preferred 0.1 to 10 mbar, exceptionally preferred 2 mbar to 5, further exceptionally preferred 3 mbar to 5 bar. Preferably any mixtures of noble gases are used as noble gases, preferably any mixtures of argon and neon, mixtures containing more neon than argon being preferred, preferably 0 vol. % argon to 100 vol. % neon, preferred 10 vol. % argon to 90 vol. % neon, particularly preferred 30 vol. % argon to 70 vol. % neon, particularly preferred is a mixture of 30 vol. % argon and 70 vol. % neon.

In a further preferred embodiment the treatment probe has a current discharging device for earthing, said device being attached preferably near the site at the probe, where contact or near contact is made with the body. With this current discharging device it is preferably any device that is capable of guiding current and it can be a liquid, a gas or preferably a device of metal, such as preferred a wire of metal, which is guided from the glass end of the probe there along to the mass. Preferably, the wire is guided along the outside or also on the inside of the probe to the mass. If the wire is guided inside the probe the probe has to be double-walled. The current discharging device, such as for example a current conductive liquid or current conductive gas, preferably a wire of metal, may also be preferably located in a tube, which is attached to the treatment probe and which is preferably made of a synthetic material, metal or preferred glass. The wire is preferably located near the site on the probe, which is in contact or near contact with the body, there being a space between the discharge, i.e. the wire, and the glass probe, preferably this is attached at the upper end of the treatment probe, said end contacting the body, wherein in a concave probe end it may also preferably be attached in the cavity, in a pointed probe end it may preferably be attached somewhere along the tip of the probe, and in a lentoid probe end it may preferably be attached at the edge of the lens. Attaching the current discharging device occurs preferably by melting, gluing or preferably attaching the wire at the upper end of the treatment probe into the glass via a clamp connection, which is pulled over the tip of the treatment probe. Said clamp connection may be formed as a ring, which may be formed from metal or preferably a synthetic material, which may preferably be rigid or preferred flexible and preferred is a silicone elastomer. Surprisingly, it has been found that even patients who are particularly algesic do now not feel any more pain with treatment probes having the current discharging device for earthing.

The source for the oxidizing gas is built such that the treatment apparatus produces the oxidizing gas directly at the glass probe, preferably from the surrounding aerial oxygen or also from pure oxygen, said treatment probe being mounted at the handle, wherein according to the principle of silent electric gas discharge an electric field is produced between two poles, here the probe and a patient, which is separated by an insulator, i.e. air. From a limiting field strength electrons are produced in the electric field through constant discharging events, said electrons splitting the oxygen contained in the ambient air into ionised oxygen, into radicals, such as highly reactive substances (oxygen in statu nascendi), such as atomic oxygen, which is mainly formed, hydroxyl ions, ozone and others. After applying an AC voltage with up to 35000 Hz a discharge event happens between the electrode, the glass probe and the patient and—associated therewith—an electric field having a high electron density. The radicals are produced by electrons hitting molecules of the air and thus achieving a higher energy level. The atomic oxygen, which is highly reactive, reacts with the germs of the application site, thus some ozone is produced, which, however, is far below the MAC (maximum allowable concentration) limit of 0.1 ppm, that is to say only at 18% of the MAC value. It is surprising that it is exactly in the amperage and frequency region according to the invention that a particularly great amount of oxygen is produced. The atomic oxygen is produced before the formation of ozone as well as during the breakup of the ozone. Insofar as it is resorbed by the tissue, the ozone formed in the treatment apparatus according to the invention breaks up in aqueous medium, particularly in dental treatment, i.e. in the intercellular substance within approx. 10 minutes to half the value of its original concentration.

Due to its low amperage and high formation of atomic oxygen the treatment apparatus according to the invention is particularly suitable for treating animals and humans at the skin surface to eliminate germs, encourage blood circulation and thus also increase lymphatic drainage. Thus it is particularly suitable for treating infected wounds, decubitus ulcers, nailbed infections, acne, headaches, migraines, haematoma, psoriasis, neurodermatitis, muscle inflammation and synovitis, general sports injuries, general dermatology, gynaecology, ophthalmology, tumors, dermatitis, infectious skin diseases, diseases of the hair follicles and sebaceous glands, hornification problems, blister forming diseases of the skin, papulosquamous diseases of the skin, warts, and odontology.

In contrast, in the prior art ozone is produced in a closed system: the ozone generator is accommodated in a carrier, from which the ozone is pumped through a silicone hose to a silicone socket, which seats fixedly on the treatment object (e.g. tooth). Only if the silicone socket is completely hermetically sealed does the ozone generator work. The ozone is changed 100 times per second in the socket. The unused ozone is returned to the carrier via a second channel in the silicone hose where it is changed back to aerial oxygen.

The high concentration of ozone of 4000000 μg/M³=2100 ppm in the prior art is very high, nevertheless, the first formation phase of atomic oxygen is not therapeutically utilised and only this eliminates the germs not the ozone, since it first has to break up into atomic oxygen to react to molecular oxygen again. In the apparatus according to the invention the proportion of atomic oxygen for eliminating germs is higher compared to the prior art by the factor of 100. According to literary data ozone is 25 times more efficient than hypochlorite (HOCL) and 5000 times more efficient than chloramine (NH₂Cl).

The apparatus according to the invention as a dental treatment apparatus kills all germs at the application site within approx. 40 seconds. The dental treatment apparatus according to the invention is preferably employed in the following fields of application.

1. Gingivitis

2. Parodontitis

3. Stomatitis (including mycosis)

4. Aphtha(s)

5. Herpes (lapialis)

6. Peri-implantitis

7. Dentitio difficilis

8. Cavity (after preparation)

9. Hypersensitivity

10. Caries superficialis (fissure caries, caries of the neck of the tooth after preparation)

11. Caries media

12. Caries profunda (residual caries)

13. Pulp trepanation/hyperemia

14. Root canal treatment (final measure)

15. Crown stumps (before cementing the crown)

16. Extraction wound(s) (coagula-stabilisation)

17. Coagulopathy (alveolitis)

18. Oozing haemorrhage(s)

19. Milling canal (before incorporation of implant)

20. Wound area (intra/post operationem)

21. Furcation affection

22. Fistula

23. Neuralgias

24. Myoarthropathies (including para functions)

It is particularly surprising that, with the treatment apparatus according to the invention, a pain-free caries treatment is possible. Excavating caries by means of technical instruments can thus be reduced to a minimum since hardly any tooth material has to be removed due to the absolute killing of germs. An injury of the dental pulp or a contamination, which nowadays result in root treatment, with loss of the vitality of the tooth can be treated successfully due to the killing of germs with the treatment apparatus according to the invention through maintaining the vitality of the tooth. It is particularly surprising that bacterially infected teeth (teeth under pus), after they have been removed from the jaw and after they and the site, from which the bacterially infected tooth has been removed, have been treated with the treatment apparatus according to the invention and thus the tooth and jaw have been made germ-free, may be re-implanted and are firmly adhered back in the jaw after no later than 10 days, such that implants have become superfluous. Through the treatment with the treatment apparatus according to the invention surgery and the administration of antibiotics can generally be avoided.

A further preferred embodiment of the treatment apparatus according to the invention is an apparatus, in which the device forming an electromagnetic field is disposed at the two ends of an open circular bail, similar to a set of headphones, terminating in a glass probe to produce the electric or electromagnetic field preferably at the musculature of the jaw. With this apparatus central neurogenic anchorages are corrected. The active principle of the device aims at the pathological processes in tense musculature and myogelosis. It forms the therapeutic basis for an extensive normalisation of the pathological conditions. Used amounts of atomic oxygen stimulate the formation of glutathione peroxidase, which activates glycolysis.

Through the principle according to the invention an oxygen saturation occurs at the haemoglobin (sufficient provision of oxygen for an aerobic muscle contraction). The rheologic properties of the blood increase. The excess of free radicals is eliminated.

At the same time magnetic field impulses stimulate the musculature. This results in a stimulation of the blood circulation and an increase in temperature. This leads to an accelerated lymphatic drainage. With the device according to the invention even highly tense jaw musculature is relaxed. This preferred embodiment of the device according to the invention is particularly suitable for prophylaxis:

1. For an exact, error-free bite-taking.

2. For neutralising tooth malposition.

3. Avoiding aggravated treatment due to limited stoma.

4. Avoiding secondary disorders, which result from an abnormal occlusion.

5. Avoiding an overexpansion due to longer treatments and for therapy of:

6. Pain relief and uncramping

7. Migraine (as a result of a malposition of the jaw joint).

8. Ailments of the spinal column (due to a malposition of the jaw joint)

9. Grinding of the teeth during the day or during the niqht

10. Arthrosis of the jaw joint (jaw joint cracking)

11. Lockjaw (locked bite)

### Efficiency Test

The starting material comprised, throughout, carious teeth, which were placed in a transport container after extraction with physiological saline solution. The following samples were made by means of steel milling wheels (bud bur with a diameter of 1.9 mm) or diamond separating disks:

Group 1 milled carious tooth material (drilling chips);

Group 2: tooth segments, prepared to the basis of the softening zone;

Group 3: tooth segments, prepared beyond the softening zone into the coloured probe hard dentine.

After their treatment all samples were stored (separately) for 24 hours in sterile isotonic sodium chloride solution per injection in the incubator at 35 degrees Celcius, then they were strongly agitated und subsequently poured each into a petri dish with Columbia-Agar (blood agar supplemented with 5 percent mutton blood) and then the bacteria suspension was distributed evenly across the entire culture medium. The incubation took place over 100 hours also at 35 degrees Celsius.

All groups were treated with the tooth treatment apparatus according to the invention for 40 seconds. Thereafter the treated petri dish of groups 1-3 was germ-free.

### FIGURES

FIG. 1 shows a preferred embodiment of the treatment apparatus according to the invention.

FIGS. 2 to 7 show preferred embodiments of the treatment probes according to the invention.

FIGS. 3 to 8 show preferred embodiments of the treatment probes according to the invention.

FIG. 8 shows a treatment probe preferably for the treatment of the skin surface.

FIG. 9 shows the additional apparatus according to the invention for the treatment apparatus according to the invention, wherein the device, which forms an electric or electromagnetic field, is disposed at the two ends of an open circular bail.

FIG. 10 shows a device, wherein a gas receiving device is slid onto the treatment probe according to the invention.

FIG. 11 illustrates a preferred embodiment of the treatment probe according to the invention with the current discharging device.

FIG. 12 shows a comb probe.

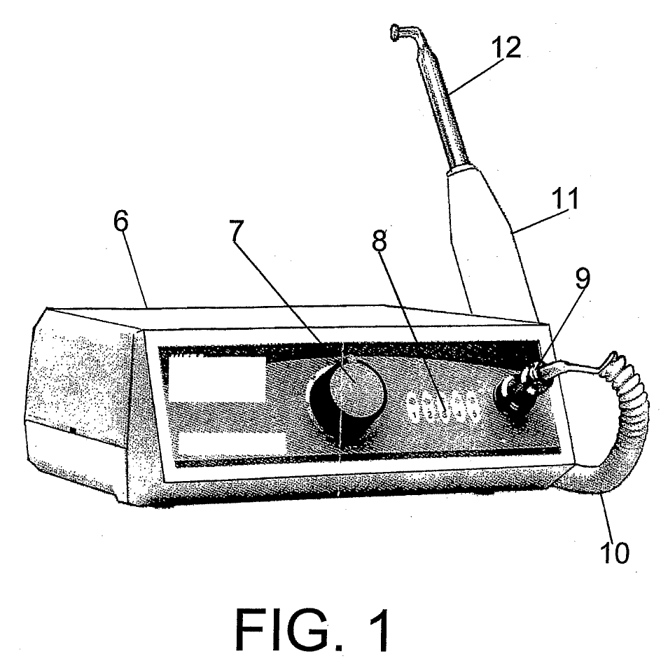

FIG. 1 illustrates a preferred embodiment of the treatment apparatus according to the invention. The treatment apparatus has, due to its design, a relatively small built carrier (6), to which an adjusting knob (7) is attached, by means of which the efficient amount of the oxydising gas is adjusted, as well as indication fields (8), by means of which the efficient amount of the oxydising gases is indicated. A helix cable (10) leading to the hand piece (11) and containing coils (not shown) is attached to the carrier via a connecting coupling (9). The probe (12), depending on the therapy, is attached at the end of the hand piece (11).

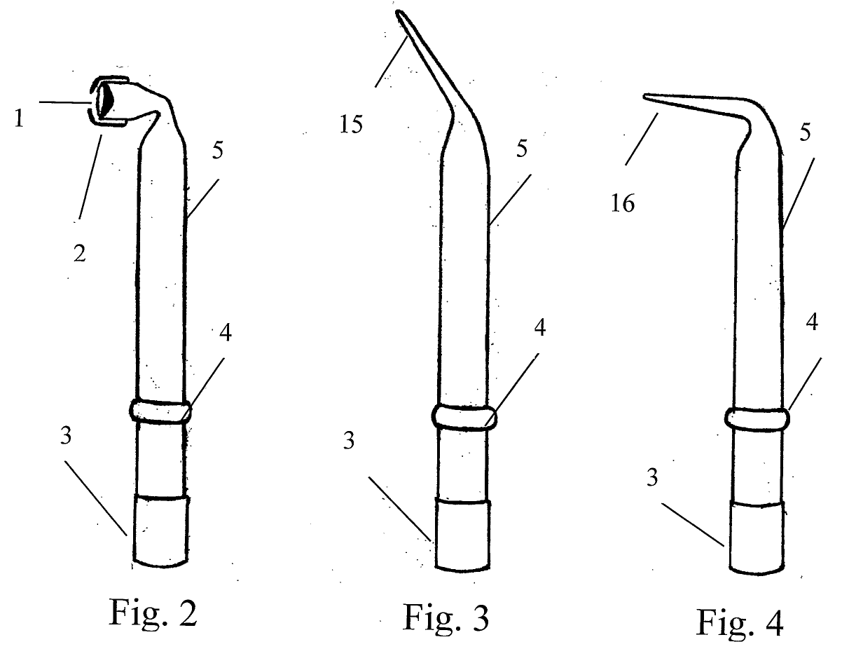

FIG. 2 shows a CA treatment probe for the treatment of caries having a preferably concave end (1) on its tip with preferably one cap (2) as a spacer, preferably of silicone, producing up to 300000 ppm atomic oxygen exclusively in the cavity. Furthermore, a cap which terminates in a capillary or a cap which grips at, around or above the tooth may also be fitted. The CA treatment probe may also be operated without the cap, which serves as a spacer. The lower end of the probe is a cylindrical metal fastener (3), the probe having a hollow glass round component (5), which has a rubber ring (4) to prevent liquids from penetrating the handle along the treatment probe, into which the treatment probe is positively stuck, and thus could pollute the contact surface between the lower metal fastener at the end of the treatment probe and the handle, said surface being difficult to clean.

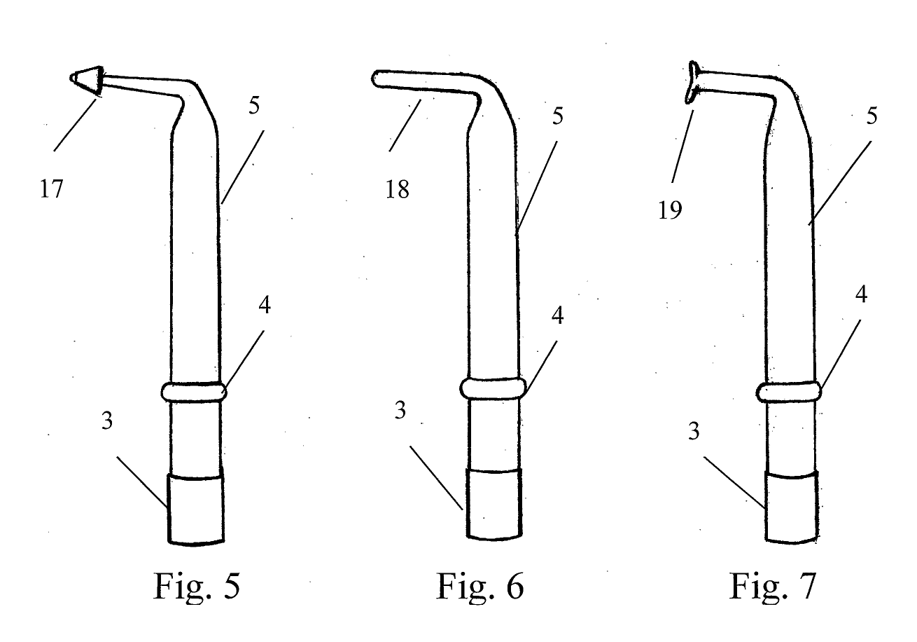

FIG. 3 shows a treatment probe, which is a PA/8 probe for Pa area 8, having at its tip (15) a fine tip at an angle of 45°, wherein the tip can preferably also be in a convex form. The carrier is as described for the treatment probe in FIG. 2.

FIG. 4 shows a treatment probe, which is a PA probe for parodontitis, having a fine tip (16) at an angle of 90°, wherein the tip can preferably also be in a convex form. The carrier is as described for the treatment probe in FIG. 2.

FIG. 5 shows a treatment probe, which is a CR probe for preferably the root canal treatment, fissures or caries, having at its tip (17) a conical end, wherein the conical end may also be formed through sticking a cone of a synthetic material on a treatment probe according to FIG. 3. The cone serves to maintain a distance to the root canal, particularly to prevent the danger of breakage of the glass probe. The tip may preferably also be convex. The carrier is as described for the treatment probe in FIG. 2.

FIG. 6 shows a treatment probe, which is an AL probe for the alveolus and a milling channel, having at its tip (18) a blunt, if applicable, spherical, preferably convex tip. The carrier is as described for the treatment probe in FIG. 2.

FIG. 7 shows a treatment probe, which is a GI probe for the gingiva, having at its tip an expanding, mushroom-shaped, preferably concave end (19). The carrier is as described for the treatment probe in FIG. 2.

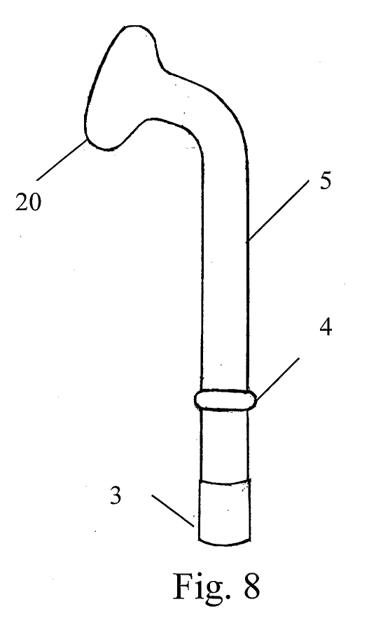

FIG. 8 is a treatment probe, preferably for the treatment of the surface of the skin with infectious or inflammed wounds and having a specially big lentoid, planar or also convex or concave end (20). The carrier is as described for the treatment probe in FIG. 2.

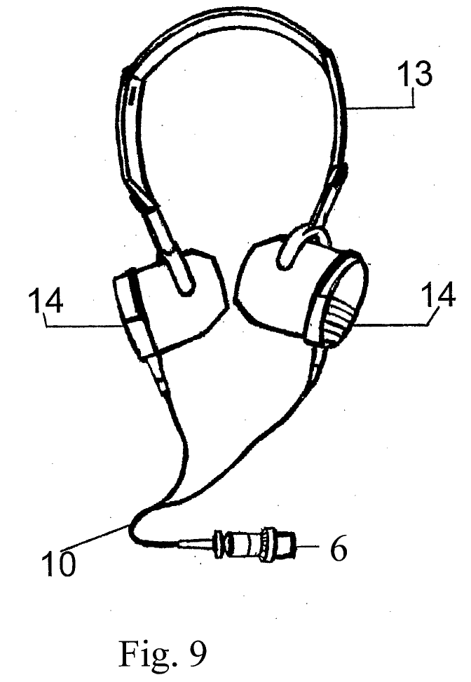

FIG. 9 shows the additional apparatus according to the invention for the treatment apparatus according to the invention, wherein the device, which forms an electric or electromagnetic field, is disposed at the two ends (14) of an open circular bail (13) and a cable (9) with a connecting coupling (10) for connecting to the treatment apparatus (9) according to the invention of FIG. 1.

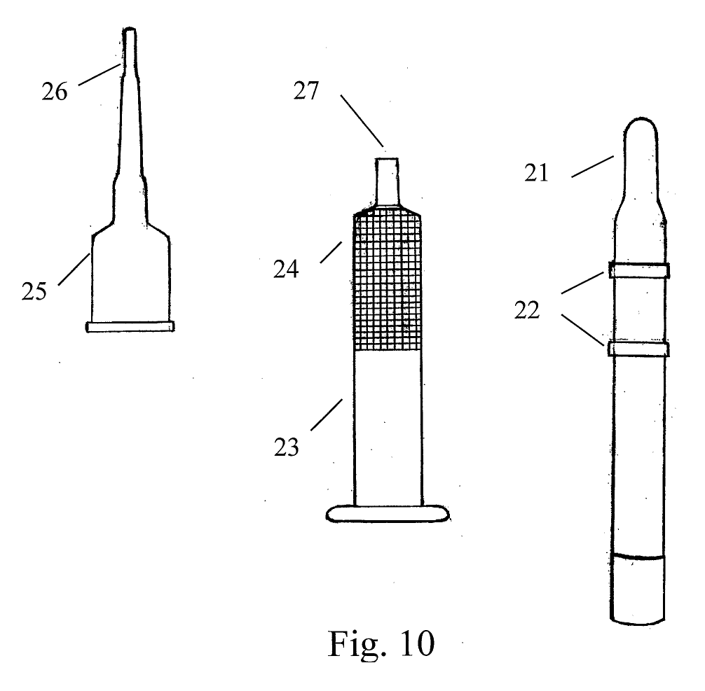

FIG. 10 shows an additional apparatus according to the invention, for which, in principle, any of the treatment probes according to the invention may be used, wherein a gas receiving device (23) is applied to the probe containing a gas, preferably an electroconductive gas. This gas receiving device (23) may be a conventional syringe (23) of a synthetic material, glass, insulated metal or also metal. It is put onto the tip of the probe (21) in a preferably gas tight manner, wherein the probe itself may still have seal rings (22) for better sealing. The gas receiving device (23) according to the invention may preferably be displaced along the longitudinal axis of the probe to transport the produced oxydising gas therein out of the gas receiving device (23). This occurs via an opening, which is open or may be closed and onto which is applied a top piece with a cannula (25) and a capillary (26), preferably of a synthetic material or metal, which is flexible or non-flexible, via which the gas is introduced into a wound pocket at the tooth, the root canal or the root resection or at other application sites, where a sterilisation is to occur. The oxidizing gas is formed from the aerial oxygen by producing an electric field through the operation of the treatment probe. The oxygen required for this is pulled up via the piston or supplied externally with a hose cable.

The gas receiving device (23) may have a metal insert (24), which is not affected by an oxydising gas, such as stainless steel, titanium, a precious metal, such as platinum, rhodium, gold, etc., which improves the production of the oxydising gas in that a finger is pressed thereon to form the counter electrode. The metal insert can be a pin, a tube or preferably a grid. In principle, the oxydising gas can also be formed without a metal insert only by pressing a finger on the front part of the gas receiving device (23).

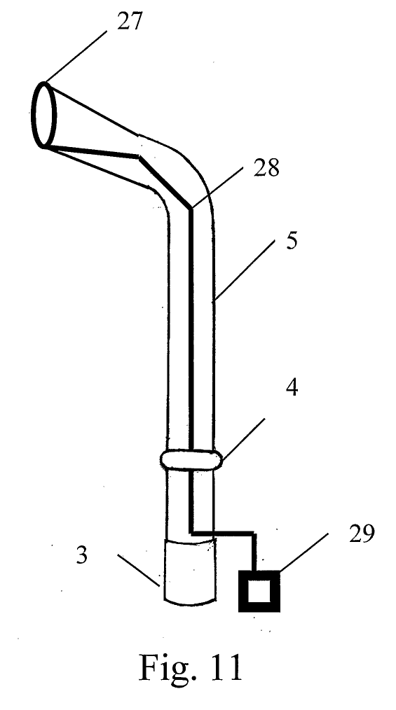

FIG. 11 is a treatment probe having the current discharging device according to the invention, said device having an attachment device (27) for preferably a wire (28), which is guided to the mass (29). The carrier is a hollow glass round component (5), which has a rubber ring (4) to prevent liquids from penetrating the handle along the treatment probe, into which the treatment probe is positively stuck, and thus could pollute the contact surface between the lower metal fastener at the end of the treatment probe and the handle, said surface being difficult to clean.

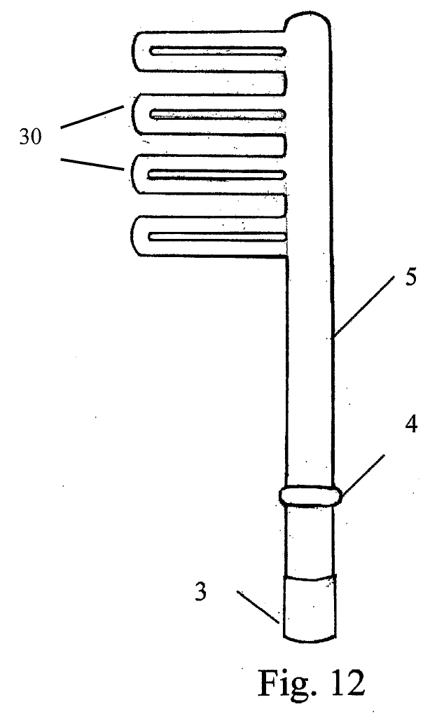

FIG. 12 shows a comb probe, which is a probe for treating diseases of the scalp or hair follicles and is in the form of a comb, the teeth (30) of the comb being, in this case, U-shaped glass tubes being connected to the carrier of the probe such that the U-shaped tubes are open toward the carrier of the probe, so that the gas may circulate unhampered in the entire probe. The carrier is as described for the treatment probe in FIG. 2.

1. A treatment apparatus, comprising a device, wherein said device produces an electric or electromagnetic field with a field voltage of 1800V to 35000V by means of a voltage of 12V to 600V, an amperage of 0.1 μA to 100 μA, and a frequency of 10000 Hz to 35000 Hz.

2. The treatment apparatus according to claim 1, wherein said produces the electric or electromagnetic field with a voltage of 12V to 50V, particularly preferred of 18V to 28V.

3. The treatment apparatus according to claims 1, wherein said device produces the electric or electromagnetic field with an amperage of 0.1 μA to 20 μA, particularly preferred with an amperage of 0.8 μA to 10 μA.

4. The treatment apparatus according to claim 1, wherein said produces the electric or electromagnetic field with a frequency of 20000 Hz to 40000 Hz, particularly preferred with a frequency of 25000 Hz to 38000 Hz.

5. The treatment apparatus according to claim 1, wherein said device producing the electric or electromagnetic field is located substantially in the handle having serially connected coils and a treatment probe.

6. The treatment apparatus according to claim 1, wherein said device producing the electric or electromagnetic field, has, as a treatment probe, a hollow glass probe which is filled with at least one electroconductive gas.

7. The treatment apparatus according to claim 1, wherein the treatment probe has a current discharging device for earthing.

8. The treatment apparatus according to claim 6, wherein the treatment probe is filled with at least one noble gas or any noble gas mixture.

9. The treatment apparatus according to claim 6, wherein the treatment probe is filled with a noble gas mixture of argon and neon.

10. The treatment apparatus according to claim 9, wherein the treatment probe is filled with a noble gas mixture of 30 vol. % argon and 70 vol. % neon.

11. The treatment apparatus according to claim 6, wherein the treatment probe is formed at its upper end as a fine tip, if applicable, convex.

12. The treatment apparatus according to claim 6, wherein the treatment probe is formed at its upper end as a conical tip, if applicable, convex.

13. The treatment apparatus according to claim 6, wherein the treatment probe is formed at its upper end as a blunt, if applicable, a spherical, if applicable, convex or concave end.

14. The treatment apparatus according to claim 6, wherein the treatment probe is formed at its upper end as a lentoid, if applicable, convex or concave end.

15. The treatment apparatus according to claim 6, wherein the treatment probe is formed at its upper end as a concave end.

16. The treatment apparatus according to claim 6, wherein the treatment probe is formed at its upper end as an extended end.

17. The treatment apparatus according to claim 6, wherein the treatment probe has at its upper end an elastic cap that is open at its upper end, or a cap, which terminates in a capillary, or a cap, which has the form of a beaker.

18. The treatment apparatus according to claim 6, wherein the treatment probe has at its upper end the form of a comb.

19. The treatment apparatus according to claim 6, wherein the treatment probe is disposed at the two ends of an open circular bail.

20. The treatment apparatus according to claim 6, wherein the treatment probe has a gas receiving device.

21. The treatment apparatus according to claim 20, wherein the gas receiving device on the treatment probe can be displaced along the longitudinal axis of the probe.

22. The treatment apparatus according to claim 20, wherein the gas receiving device on the treatment probe has a metal insert.

23. The treatment apparatus according to claim 20, wherein the gas receiving device on the treatment probe has an opening on one end, said opening being open or can be closed.

24. The treatment apparatus according to claim 21, wherein the gas receiving device on the treatment probe connects to a cannula, which has a flexible or a non-flexible capillary.
